(19) United States
(12) Patent Application Publication
(10) Pub. No.: US 2022/0308988 A1
(43) Pub. Date: Sep. 29, 2022

(54) GENERATING PROJECT REQUIREMENTS USING TEST SCRIPTS

(71) Applicant: International Business Machines Corporation, Armonk, NY (US)

(72) Inventors: Lee Thomas, Bend, OR (US); Manus Kevin McHugh, Colorado Springs, CO (US)

(21) Appl. No.: 17/211,907

(22) Filed: Mar. 25, 2021

(51) Int. Cl. G06F 11/36; G06F 8/10

(52) U.S. Cl. CPC G06F 11/3684; G06F 8/10

(57) ABSTRACT

A method, computer program product and computer system for generating requirements for a project are provided. A processor retrieves a test script for the project. A processor parses one or more sentences from the test script. Responsive to identifying a sentence with a present-tense verb, a processor transforms the verb tense of the sentence to a modal auxiliary-verb format. A processor generates a requirements document associated with the project with the modal auxiliary-verb formatted sentence.

### BACKGROUND OF THE INVENTION

The present invention relates generally to the field of requirements analysis, and more particularly to generating requirements based on input from test scripts.

Requirements analysis is the process of analyzing, documenting, validating and managing software or system requirements for a product, platform or any other type of system. As the products and systems are being developed, various requirements of the product or system need to be documented such that project managers are aware of what is required to fulfill the current and changing needs of the stakeholders of the project. For larger and/or more iterative projects, various tests are created as changes to the needs of the stakeholders arise during development. For software and process management type projects, tests scripts are lists of instructions or steps that provide the necessary operations and inputs steps needed to be performed in order to test various aspects of the product.

### SUMMARY

Embodiments of the present invention provide a method, system, and program product for generating requirements for a project are provided. A processor retrieves a test script for the project. A processor parses one or more sentences from the test script. In response to identifying a sentence with a present-tense verb, a processor transforms the verb tense of the sentence to a modal auxiliary-verb format. A processor generates a requirements document associated with the project with the modal auxiliary-verb formatted sentence.

### BRIEF DESCRIPTION OF THE SEVERAL VIEWS OF THE DRAWINGS

FIG. 1 is a functional block diagram illustrating a networked environment, in accordance with an exemplary embodiment of the present invention.

FIG. 2 illustrates operational processes of a requirement management program, on a computing device within the environment of FIG. 1, in accordance with an exemplary embodiment of the present invention.

FIG. 3 depicts an example block diagram for automatically generating requirements from test scripts.

FIG. 4 depicts a block diagram of components of the computing device executing a requirement management program, in accordance with an exemplary embodiment of the present invention.

### DETAILED DESCRIPTION

While solutions to generating engineering requirements are known, the process is typically manual, with the requirements being entered manually by a user. Embodiments of the present invention recognize that by providing an automatic process of automatically generating the engineering requirements, an improvement to prior requirements management solutions is provided. Typically, during development, prototyping of new features serve as an initial introduction of new features of the product or service. During prototyping, various tests are written by the designers and developers. Embodiments of the present invention recognize that by digesting via Natural Language Processing (NLP) the various steps of the tests, changes to the test can indicate new potential requirements of the product or service. After parsing and transforming the new steps of a test, embodiments of the present invention automatically generate new requirements in an engineering requirements document. Additionally, embodiments of the present invention recognize that previously provided test scripts may also be analyzed to determine if the requirements for the project reflect other undocumented or forgotten tests performed prior to deployments of the invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

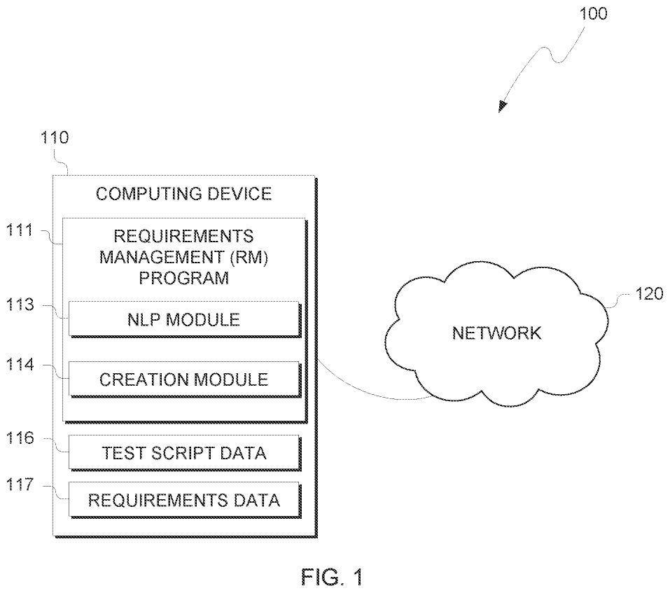

The present invention will now be described in detail with reference to the Figures. FIG. 1 is a functional block diagram illustrating networked environment, generally designated 100, in accordance with one embodiment of the present invention. Networked environment 100 includes computing device 110 connected over network 120. Computing device 110 includes Requirements Management (RM) program 111, test script data 116 and requirements data 117. RM program 111 includes Natural Language Processing (NLP) module 113 and creation module 114.

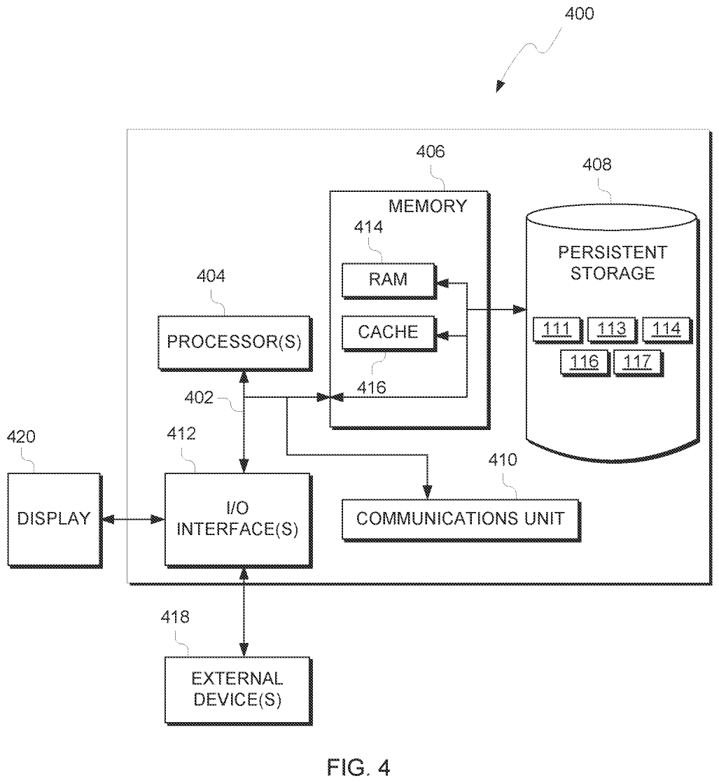

In various embodiments of the present invention, computing device 110 can be a standalone device, a server, a laptop computer, a tablet computer, a netbook computer, a personal computer (PC), or a desktop computer. In another embodiment, computing device 110 represents a computing system utilizing clustered computers and components to act as a single pool of seamless resources. In general, computing device 110 can be any computing device or a combination of devices with access to test script data 116 and requirements data 117 and is capable of executing RM program 111. Computing device 110 may include internal and external hardware components, as depicted and described in further detail with respect to FIG. 4.

In this exemplary embodiment, RM program 111, test script data 116 and requirements data 117 are stored on computing device 110. However, in other embodiments, RM program 111, test script data 116 or requirements data 117 may be stored externally and accessed through a communication network, such as network 120. Network 120 can be, for example, a local area network (LAN), a wide area network (WAN) such as the Internet, or a combination of the two, and may include wired, wireless, fiber optic or any other connection known in the art. In general, network 120 can be any combination of connections and protocols that will support communications between computing device 110 and other devices, such as but not limited, to servers with access to RM program 111, test script data 116 or requirements data 117 and any devices related to the testing of a platform, product or service, in accordance with a desired embodiment of the present invention.

In various embodiments, RM program 111 is a requirements management software suite that provides various functions to provide requirements analysis during development of a product or service such as, but not limited to, the collection and maintenance of requirements data 117. In various embodiments, RM program 111 includes test management functions that collect and track various tests, represented as test script data 116. While not shown for brevity, computing device 110, and by extension RM program 111, may be communicatively coupled to a testing environment or platform in which test script data 116 may be performed for testing purposes during development.

In various embodiments, test script data 116 includes various scripts, lists, or series of steps to verify various aspects of a product or service are within satisfaction or compliance. As used herein, test script data 116 refers to any storage system or device that contains, or otherwise points to, a list of steps to be performed to verify that the product or service, or component thereof, is properly functioning. In some scenarios, test scripts data 116 includes various manual steps that a human operator must perform to ensure proper operation. In other scenarios, test script data 116 includes machine readable code or pseudo-code that can be automatically executed by a device, without human intervention.

In some scenarios and embodiments, components of a software product are composed of commercial off-the-shelf or COTS software, that are typically developed separately from the software product in which they will be integrated into. The various supporting COTS software are typically accompanied with test scripts to ensure proper usage or deployment that are either provided directly from a maintainer of the COTS software or by a third party. However, how the software is deployed and the potential use cases of the COTS software are not known by the COTS supplier. Therefore, a developer using the COTS software will need to generate the requirements, such as requirements data 117, for the end product or service manually.

Embodiments of the present invention recognize that by digesting and parsing test scripts via a Natural Language Processing (NLP) tool, such as NLP Module 113, that requirements data 117 can be derived and automatically generated, eliminating the need to manually enter requirements of the component COTS software utilized in the product or service being developed. While some requirements may still need to be entered manually if not provided in a test script (e.g., non-functional requirements and other specific customer requirements such as cost), embodiments of the present invention recognize that by identifying engineering requirements in a test script and then re-formatting the relevant portions of the test script, an engineering requirements document can be automatically generated or updated with the re-formatted relevant portions of the test script.

In various embodiments, RM program 111 identifies one or more test scripts associated with an ongoing development project for analysis by NLP module 113. For example, RM program 111 identifies newly uploaded or created test scripts that are stored in test script data 116. In another example, RM program 111 identifies changes to test scripts as they are made to previous versions of test scripts that are stored in test script data 116. As discussed herein and in various embodiments, test script data 116 includes one or more previously generated test scripts from a COTS supplier or third party; one or more user-generated test from developers of the project; or one or more stakeholder developed tests supplied to the developers.

In various embodiments, test script data 116 includes a series of steps that need to be performed to verify the functions of devices and software in a production or testing environment. For example, a test script to verify that a “Change Password” feature in a software product/service would list various steps required to verify that the feature is functional (i.e., “Click Change Password Button”, “Re-enter Password in ‘Old Password Field”, “Enter New Password in ‘New Password’ Field”, “Click the Submit Button”, and “The Software Sends a Password Change Success Event to User”).

In various embodiments, requirements data 117 include the various requirements of the product or service. For example, requirements for a home security app may include statements such as “The home security app shall notify the user immediately if an alarm event occurs” and “The home security app shall deactivate an alarm after being reset by the user”. In various embodiments, requirements data 117 includes a variety of requirements types including, but not limited to, functional requirements, non-functional requirements, performance requirements, customer requirements, structural requirements, or behavioral requirements.

In various embodiments, RM program 111 identifies one or more test scripts stored in test script data 116 for analysis regarding potential requirements added or changed by the one or more test scripts. In various embodiments, NLP module 113 digests the test script to determine the semantical content of the various steps provided in the test script. As will be discussed in greater detail herein, NLP module 113 identifies sentences in the test script that have a present tense verb. NLP module 113 then transforms the identified sentences with present tense verbs using a modal format. For example, returning to the “Change Password” test script, NLP module 113 would identify the step represented by the sentence “The Software Sends a Password Change Success Event to User” would be transformed into a modal form such as “The Software Should Send a Password . . . ” or “The Software Must Send a Password”. A modal verb is an auxiliary verb that conveys the capacity or ability to perform something. Example modal auxiliaries include “can”, “could”, “may”, “might”, “must”, “shall”, “should”, “will” and “would”. In various embodiments, NLP module 113 identifies imperative statements since those statements are typically associated with steps to be performed during the test and not a result (e.g., “Click Change Password Button” or “Re-enter Password in ‘Old Password Field”). Imperative sentences are commands or instructions that tell what someone should do. NLP module 113 identifies imperative statements based on a lack of a main subject in the sentence (e.g., “Click Change Password Button” where the subject is implied as the user and not stated) and only includes objects (e.g., “Button” or “Field) to which the action is applied to, which is typical of instructions in a test script.

In various embodiments, NLP module 113 identifies and collates imperative statements to re-format the identified imperative sentences to a perfect tense form. Perfect tense verbs are verb formats that are used to express a completed action. The term “perfect” indicates that the action or clause in the statements has been stated to be fully complete. For example, for the imperative statement in the “Change Password” test script that states “Click Change Password Button”. In this example, NLP module 113 modifies or re-formats the imperative statement with a present perfect tense verb as “Clicks Change Password Button”, where “Clicks” conveys a present tense completion of the task of “Click”. By extracting and identifying sentences in imperative form, NLP module 113 can identify the pre-requisites or steps required to perform a test.

By identifying present tense verbs in non-imperative formats, NLP module 113 identifies sentences of test script data 116 that are related to recognizing correct output associated with the test and, as such, are potential requirements of proper operation of the parts of the product related to the test script being analyzed. In various embodiments, NLP module 113 re-formats the sentence to include a modal auxiliary verb so that the sentence is now a statement of capability of the product or service being developed; thereby making the sentence a feature or requirement of the product or service being tested.

In various embodiments, creation module 114 receives the re-formatted sentences from NLP module 113 and automatically generates a respective engineering requirements document in requirements data 117 associated with the product or service being tested. For more complex projects with multiple components with separate requirement documents, NLP module 113 determines a subject matter of the test script and identifies an existing requirements document with similar subject matter, and then instructs creation module 114 of the relevant requirements document. For example, a test script includes numerous sentences about routers and communications equipment. In this example, NLP module 113 determines that the content is directed to telecommunications and identifies a requirements document in requirements data 117 that includes requirements within the same domain of “telecommunications”.

By extracting sentences from test scripts that are not in imperative form, embodiments of the present invention can identify the resultant portions of a test script, which typically indicate measurable or observable outcomes that would serve as potential requirements in an engineering requirements analysis. By automatically generating requirements data 117 with the resultant portions of a test script and modifying the sentence into a modal form, RM program 111 automatically generates an engineering requirements document. Additionally, RM program 111 includes transformed imperative statements with perfect tense as pre-requisites in the engineering requirements document. As test scripts are created, RM program 111 saves users from additional work of generating an engineering requirements document in requirements data 117.

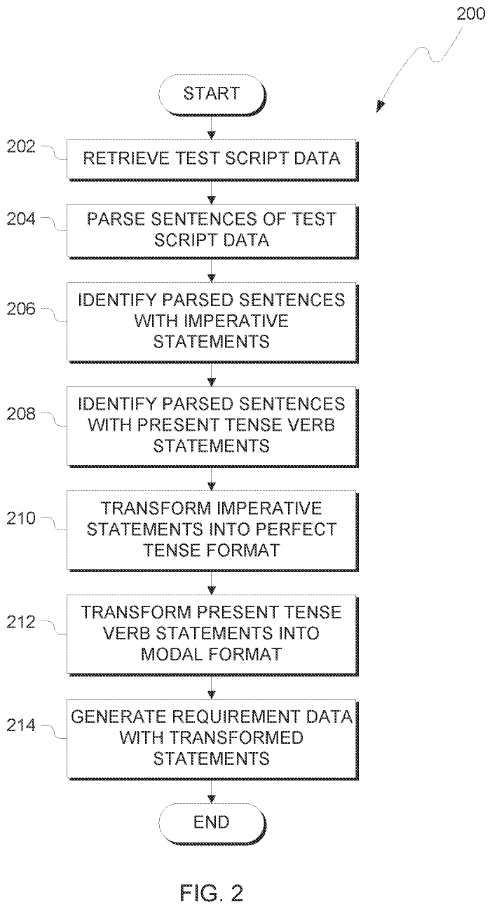

FIG. 2 illustrates operational processes, generally designated as 200, of RM program 111. In process 202, RM program 111 retrieves test script data 116. Test script data 116 includes various test steps or scripts that test the functionality of a product or service being developed, or any components parts or steps that comprise the product or service. In process 204, RM program 111 parses the sentences of the retrieved test script data 116. NLP module 113 includes a parsing operation. Initially, NLP module 113 separates the various sentences contained in test script data 116 and parses each sentence. First NLP module 113 segments each sentence into a separate delineation for analysis. After breaking test script data 116 into sentences, NLP module 113 breaks the sentences apart into tokens or atomic logical terms (e.g., short sentences, phares or words). Then, NLP module 113 assigns “parts of speech” tags to the various tokens such as “noun”, “verb”, “proper noun” “adjective” as well as “imperative”, “non-modal verb”, “modal verb” and “present tense verb”.

In process 206, RM program 111 identifies imperative sentences or tokens present in test script data 116. As previously discussed, RM program 111 identities imperative sentences digesting test script data 116 based on a lack of a subject in the sentence. In process 208, RM program 111 identifies the parsed sentences with present tense verbs. As previously discussed, tokens that include present-tense verbs often indicate observations that need to be made, which would typically indicate a requirement for proper operation of the product or component that the test script is applicable to testing. In some embodiments, RM program 111 identifies sentences for inclusion in requirement data 117 based on the presence of “subject” in the token. As previously discussed, imperative statements typically lack subjects, as the subject (i.e., the test operator) is implied (e.g., “Click the button” versus “The Operator clicks the button”).

In process 210, RM program 111 transforms the parsed sentences with imperative statements into a perfect tense format. Perfect tense verbs indicate that an action or clause of the sense has been completed. In process 212, RM program 111 transforms the parsed sentences with present-tense verbs into a modal format. Modal verbs are auxiliary verbs that transform a sentence in a one that conveys the capacity or ability to perform something. Additionally, in both processes 210 and 212, RM program 111 ensure the resulting transformed sentence is grammatically correct regarding verb conjugation for the verb being modified by the modal auxiliary verb. In process 214, RM program 111 automatically generates requirements data 117 with the transformed modal format generated in process 212 and transformed perfect tense formats generated in process 210. As previously discussed, the resulting sentences that are generated by RM program 111 into requirements data 117 state the observable outcomes of test script data 116 in a functional manner found in engineering requirement documents, thereby automating the manual activity of generating requirements data 117 when new test scripts are derived.

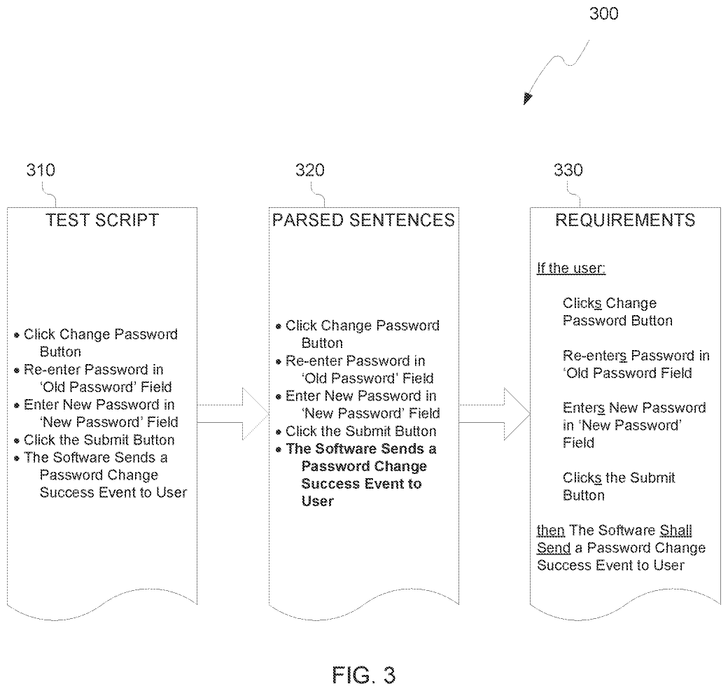

FIG. 3 depicts an example block diagram, generally designated 300, of automatically generating requirements from test scripts. Test script 310 includes a variety of steps required to test a database backup operation over a direct communication with a server over a modem. Test script 310 includes the steps of previously discussed regarding the “Change Password” test script (i.e., “Click Change Password Button”, “Re-enter Password in ‘Old Password Field”, “Enter New Password in ‘New Password’ Field”, “Click the Submit Button”, and “The Software Sends a Password Change Success Event to User”).

Parsed sentences 320 includes the intermediate output created and formatted by NLP Module 113 of RM program 111, as discussed herein. RM program 111 identifies the imperative statements of “Click Change Password Button”, “Re-enter Password in ‘Old Password Field”, “Enter New Password in ‘New Password’ Field”, “Click the Submit Button”, as indicated via the unemphasized text as depicted in FIG. 3. RM program 111 identifies such steps in test script data 116 to be included in requirements 330 as re-formatted perfect-tense sentences (e.g., “Clicks . . . ” or “Enters”), as indicated by the bolded portions of parsed sentences 320. Requirements 330 also includes the non-impetrative statements included in parsed sentences 320.

As discussed herein, RM program 111 re-formats or transforms non-imperative parsed sentences 320 to include a modal auxiliary verb form (i.e., “should” and “must”) such that the sentences are in a form typically found in engineering requirement documents as the observable outcome in a testing scenario. In some scenarios and embodiments, RM program 111 collects and formats both imperative and non-imperative statements as discussed herein, where imperative statements are transformed into a perfect tense format and non-imperative statements are transformed into a modal format. Additionally, RM program 111 generates and formats requirements 330 such that the requirements present both the steps and results as digested and identified by NLP module 113, in an if-then format, where the imperative statements transformed into a perfect tense format are listed as the steps required to verify the requirement and non-imperative statements that are transformed into a modal format as being the results or state that is required to verify proper operation.

In some embodiments and scenarios, RM program 111 extracts and analyzes portions of code or automated test scripts from test script 310. An example automated test script that would implement the “Change Password” test script would include the following lines of pseudo-code: “changePasswordButton.click( );”, “oldPasswordField.type(‘myOldPassword’);”, “newPasswordField.type(‘my new 15+ character passphrase’);” “submitButton.click( );” and messageArea.verify(‘You have successfully changed your password’);”. In such embodiments and scenarios, RM program 111 decomposes or parses the various statements, for input or other data entry type statements, RM program 111 functionally decomposes the statements into natural language statements that reflect the input or action that is being performed by the automated test script. For example, RM program 111 would transform the script of “changePasswordButton.click( );” to “Perform ‘click’ action on “changePasswordButton” Object. As another example, RM program 111 would transform the script of “newPasswordField.type(‘my new 15+ character passphrase’)” to “Perform a ‘type’ function in the “newPasswordField’”. Additionally, RM program 111 identifies output statements based on functional decomposition of the statement, identifying the statement includes output. For example, the line of code “messageArea.verify(‘You have successfully changed your password’)” includes an interaction with an output object of “messageArea” thereby identifying that the statement should create some observable output, thereby indicating an observable requirement of the test script. In this example, RM program 111 would reformat the code statement into a natural language statement that would state “The ‘PasswordChangemodule” shall send a “verify” message to “MessageArea” stating ‘You have successfully changed your password’.

FIG. 4 depicts a block diagram, 400, of components of computing device 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computing device 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

RM program 111, test script data 116 or requirements data 117 are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of network 120. In these examples, communications unit 410 includes one or more network interface cards. Communications unit 410 may provide communications through the use of either or both physical and wireless communications links. RM program 111, test script data 116 or requirements data 117 may be downloaded to persistent storage 408 through communications unit 410.

I/O interface(s) 412 allows for input and output of data with other devices that may be connected to computing device 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., RM program 111, test script data 116 or requirements data 117, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

What is claimed is:

1. A method for generating requirements for a project, the method comprising:
retrieving, by one or more processors, a test script for the project;
extracting, by the one or more processors, one or more functional statements from the test script;
responsive to identifying a functional statement with a present-tense verb, transforming, by the one or more processors, the verb tense of the functional statement to a modal auxiliary-verb format; and
generating, by the one or more processors, a requirements document associated with the project with the modal auxiliary-verb formatted functional statement, wherein the requirements document includes the extracted and transformed functional statements of the test script.

2. The method of claim 1, the method further comprising:
in response to identifying a second functional statement with an imperative statement, transforming, by the one or more processors, the verb tense of the second functional statement to a perfect-verb tense format.

3. The method of claim 2, wherein the modal auxiliary-verb formatted functional statement is a requirement for the project.

4. The method of claim 3, wherein the perfect-verb tense formatted second functional statement is a pre-requisite for the requirement for the project.

5. The method of claim 4, wherein the requirements document is structured as an if-then statement.

6. The method of claim 1, wherein the test script includes at least one machine readable statement.

7. The method of claim 6, the method further comprising:
decomposing, by the one or more processors, the at least one machine readable statement; and
generating, by the one or more processors, the requirements document associated with the project with the composition of a function included in the at least one machine readable statement.

8. A computer program product for generating requirements for a project, the computer program product comprising:
one or more computer-readable storage media and program instructions stored on the one or more computer-readable storage media, the program instructions comprising:
program instructions to retrieve a test script for the project;
program instructions to extract one or more functional statements from the test script;
responsive to program instructions to identify a functional statement with a present-tense verb, program instructions to transform the verb tense of the functional statement to a modal auxiliary-verb format; and
program instructions to generate a requirements document associated with the project with the modal auxiliary-verb formatted functional statement, wherein the requirements document includes the extracted and transformed functional statements of the test script.

9. The computer program product of claim 8, the method further comprising:
in response to program instructions to identify a second functional statement with an imperative statement, program instructions to transform the verb tense of the second functional statement to a perfect-verb tense format.

10. The computer program product of claim 9, wherein the modal auxiliary-verb formatted functional statement is a requirement for the project.

11. The computer program product of claim 10, wherein the perfect-verb tense formatted second functional statement is a pre-requisite for the requirement for the project.

12. The computer program product of claim 11, wherein the requirements document is structured as an if-then statement.

13. The computer program product of claim 8, wherein the test script includes at least one machine readable statement.

14. The computer program product of claim 13, the program instructions further comprising:
program instructions to decompose the at least one machine readable statement; and
program instructions to generate the requirements document associated with the project with the composition of a function included in the at least one machine readable statement.

15. A computer system for generating requirements for a project, the computer system comprising:
one or more computer processors;
one or more computer readable storage media; and
program instructions stored on the computer readable storage media for execution by at least one of the one or more processors, the program instructions comprising:
program instructions to retrieve a test script for the project;
program instructions to extract one or more functional statements from the test script;
responsive to program instructions to identify a functional statement with a present-tense verb, program instructions to transform the verb tense of the functional statement to a modal auxiliary-verb format; and
program instructions to generate a requirements document associated with the project with the modal auxiliary-verb formatted functional statement, wherein the requirements document includes the extracted and transformed functional statements of the test script.

16. The computer system of claim 15, the method further comprising:
in response to program instructions to identify a second functional statement with an imperative statement, program instructions to transform the verb tense of the second functional statement to a perfect-verb tense format.

17. The computer system of claim 16, wherein the modal auxiliary-verb formatted functional statement is a requirement for the project.

18. The computer system of claim 17, wherein the perfect-verb tense formatted second functional statement is a pre-requisite for the requirement for the project.

19. The computer system of claim 18, wherein the requirements document is structured as an if-then statement.

20. The computer system of claim 15, wherein the test script includes at least one machine readable statement.
